(19) United States
(12) Patent Application Publication
(10) Pub. No.: US 2011/0276719 A1
(43) Pub. Date: Nov. 10, 2011

(54) TRADING MECHANISM

(75) Inventors: Burkhard Sturm, Krefeld (DE); Thomas Pliakas, Athens (GR); Tiju Titus John, Bangalore (IN); Balasubramanian Manoharan, Bangalore (IN); Jyri Seiger, Espoo (FI); Mika Kristian Skarp, Espoo (FI)

(73) Assignee: NOKIA SIEMENS NETWORKS OY, Espoo (FI)

(21) Appl. No.: 12/776,869

(22) Filed: May 10, 2010

(51) Int. Cl. G06F 15/173

(52) U.S. Cl. 709/241

(57) ABSTRACT

The present invention relates to methods and apparatus for buying connectivity. A routing engine 103 may receive a buyer request for a connectivity path wherein the buyer request includes a buyer criteria. The routing engine 103 may identify one or more connectivity paths wherein each identified connectivity path comprises one or more connectivity legs. The routing engine 103 may determine one or more available connectivity paths based on the buyer criteria and the routing engine 103 may select an optimal connectivity path from the determined available connectivity paths.

The present invention relates to a trading mechanism and, in particular, to buying a connectivity path.

If a first customer requires a connectivity path between two points for their own use or to supply services to their users then the first customer has to contact a first network operator in order to determine if the required connectivity path is available. The first customer will have to negotiate with the first network operator in order to obtain the required connectivity path which may take a substantial period of time before the connectivity path is provisioned and fulfilled.

However, the connectivity path required by the first customer may span several different network operators which means that the first customer may need to contact and negotiate with all of the operators, or may have to wait for the first network operator to negotiate with the other network operators on behalf of the first customer. Therefore, there may be a substantial delay and difficulty in obtaining the connectivity path that the first customer requires.

Moreover, the one or more of the network operators may have sold some part of the required connectivity path to a second customer. The second customer may not be utilising all of the capacity they have obtained or be utilising the capacity at particular times. However, as the network operator may have sold the connectivity to the second customer and it will be considered unavailable by the network operator. The second customer may contact the network operator (or network operators if their connectivity spans more than one network operator's network) to offer the capacity back to the network operator but this may not be accepted by the network operator as they have been paid for the connectivity and so the connectivity (or capacity on the connectivity path) may remain unused.

Thus, there is a need to provide a more flexible, efficient and effective mechanism for requesting and obtaining a connectivity path. There is also a need to provide a more flexible, efficient and effective mechanism for network operators, customers, etc, to offer spare capacity for use by another party. Many of the embodiments seek to address one or more of the identified needs.

According to a first aspect of the present invention there is provided a method comprising: receiving a buyer request for a connectivity path wherein the buyer request includes a buyer criteria; identifying one or more connectivity paths wherein each identified connectivity path comprises one or more connectivity legs; determining one or more available connectivity paths based on the buyer criteria; and selecting an optimal connectivity path from the determined available connectivity paths.

Therefore, the buyer requests a connectivity path where the buyer request includes buyer criteria. A connectivity path may be considered a whole path between point A and point B over which data may be transmitted between A and B. The connectivity path may be considered a single path that may include one or more connectivity legs where each connectivity leg could span a different network operator's network. However, the buyer may only be aware of, or needs, the end to end connectivity path and so is not aware of, nor cares about, the individual connectivity legs or the actual physical connections of the connectivity path. In order to provide a connectivity path the connectivity path may require sufficient capacity for the buyer's needs to transmit or receive data. Therefore, the connectivity legs of the connectivity path may need sufficient capacity for the buyer's needs.

The buyer criteria may include any criteria relating to the buyer request. For example, the buyer criteria may include a start point of the connectivity path, an end point of the connectivity path, service level parameters, a start time, an end time or a duration, price, and so on. The service level parameters may include, for example, bandwidth, jitter, packet loss, availability, delay, and so on. The price may refer to a total price or price range for the connectivity path, a total price or price range for each possible leg that may be part of the connectivity path. The price may be left empty which may indicate the buyer is willing to agree to the price requested for the connectivity path (or any leg that is part of the connectivity path).

The buyer criteria mentioned hereinabove are examples of criteria that the buyer may specify or define. The buyer criteria may include one or more of the criteria mentioned above or may include any other criteria necessary in order to define and obtain the connectivity they require.

Available connectivity paths may be determined based on the relevant criteria of the buyer criteria where the available connectivity paths are those connectivity paths that fulfil the relevant criteria of the buyer criteria. The relevant criteria may be the criteria that relates to the connectivity path, for example, the service level parameters. As will be appreciated, not all the criteria of the buyer criteria that may be supplied by the buyer may be relevant to the connectivity path.

An optimal connectivity path for the buyer may be selected from the one or more available connectivity paths.

Accordingly, the method provides a flexible and efficient mechanism for determining and selecting a connectivity path for a buyer to meet the buyer's needs and requirements. The buyer does not have to negotiate or contact each supplier of each connectivity leg for the connectivity path. Therefore, the buyer may only need to know the start and end point of a connectivity path and does not need to know where or how the connectivity path is physically implemented. In other words, the buyer requests and buys an abstract product in the form of a connectivity path.

The step of determining one or more available connectivity paths may further comprise determining if each of the one or more connectivity legs of the identified connectivity path fulfils relevant criteria of the buyer criteria. Thus, in order to determine an available connectivity path it may be determined whether each connectivity leg fulfils the buyer criteria that may relate to the connectivity leg.

The step of determining one or more available connectivity paths may further comprise determining if the identified connectivity path fulfils relevant criteria of the buyer criteria. Thus, in order to determine an available connectivity path it may be determined whether each identified connectivity path (e.g. the path as a whole) fulfils the buyer criteria that may relate to the whole connectivity path.

The step of selecting an optimal connectivity path from the determined available connectivity paths may comprise determining a weighting value for each determined one or more available connectivity paths; and selecting the available connectivity path with the optimum weighting value as the optimum connectivity path. Thus, if more than one available connectivity path may be determined, in other words more than one connectivity path that may meet the buyer request, then the optimum connectivity path may be selected based on a weighting value. The weighting value may be based on the buyer criteria. For example, if the buyer states that the most important criteria is price then the cheapest connectivity path may have the lowest/highest weighting value so that the optimum connectivity path can be selected. The weighting value mechanism may aggregate several weighting values the importance of which may be ranked by the buyer in the buyer criteria.

The method may further comprise reserving the one or more connectivity legs of the selected optimum connectivity path. Thus, the connectivity legs of the selected optimal path may be reserved for the buyer which may prevent other buyer's from using the connectivity bought by the buyer.

The method may further comprise provisioning the selected optimal connectivity path such that the buyer can utilise the selected optimal connectivity path. Thus, the connectivity path can be automatically provisioned. For example, each network operator of the physical network connection that the connectivity legs of the connectivity path spans can automatically be instructed to provision the relevant connectivity legs for the buyer.

Each of the one or more connectivity legs may be offered for use by a seller and may include seller criteria. Thus, the step of determining one or more available connectivity paths may further comprise determining if relevant criteria of buyer criteria for each connectivity leg of the identified connectivity path fulfils relevant criteria of the seller criteria of each of the connectivity legs. Thus, in order for a connectivity leg to be available to the buyer then the seller criteria may also need to be fulfilled so that the seller may sell the connectivity leg to the buyer.

According to a second aspect of the present invention there is provided an apparatus comprising: a first input adapted to receive a buyer request for a connectivity path wherein the buyer request includes a buyer criteria; a first processor adapted to identify one or more connectivity paths wherein each identified connectivity path comprises one or more connectivity legs; a second processor adapted to determine one or more available connectivity paths based on the buyer criteria; and a third processor adapted to select an optimal connectivity path from the determined available connectivity paths.

According to a third aspect of the present invention there is provided an apparatus adapted to: receive a buyer request for a connectivity path wherein the buyer request includes a buyer criteria; identify one or more connectivity paths wherein each identified connectivity path comprises one or more connectivity legs; determine one or more available connectivity paths based on the buyer criteria; and select an optimal connectivity path from the determined available connectivity paths.

The second processor may be further adapted to determine if each of the one or more connectivity legs of the identified connectivity path fulfils relevant criteria of the buyer criteria.

The second processor may be further adapted to determine if the identified connectivity path fulfils relevant criteria of the buyer criteria.

The third processor may be further adapted to determine a weighting value for each determined one or more available connectivity paths; and select the available connectivity path with the optimum weighting value as the optimum connectivity path.

The apparatus may further comprise a fourth processor adapted to reserve the one or more connectivity legs of the selected optimum connectivity path. The apparatus may further comprise a fifth processor adapted to provision the selected optimal connectivity path such that the buyer can utilise the selected optimal connectivity path.

Each of the one or more connectivity legs may be offered for use by a seller and may include seller criteria; wherein the second processor may be further adapted to determine if relevant criteria of buyer criteria for each connectivity leg of the identified connectivity path fulfil relevant criteria of the seller criteria of each of the connectivity legs.

The apparatus may be a computing device, for example, a server, computer, and so on. The first processor, second processor, third processor, fourth processor and fifth processor may be the same processor, different processors or any combination thereof.

As a skilled person in the art will appreciate, the apparatus may be adapted to perform the functions in many different ways. For example, the apparatus may be adapted by software, hardware or any combination thereof.

According to a fourth aspect of the present invention there is provided a computer program product comprising computer readable executable code for: receiving a buyer request for a connectivity path wherein the buyer request includes a buyer criteria; identifying one or more connectivity paths wherein each identified connectivity path comprises one or more connectivity legs; determining one or more available connectivity paths based on the buyer criteria; and selecting an optimal connectivity path from the determined available connectivity paths.

The computer program product may further comprise computer readable executable code for performing any or all of the functions and features in accordance with the aspects of the invention.

Embodiments of the present invention will not be described, by way of example only, and with reference to the accompanying drawings in which:

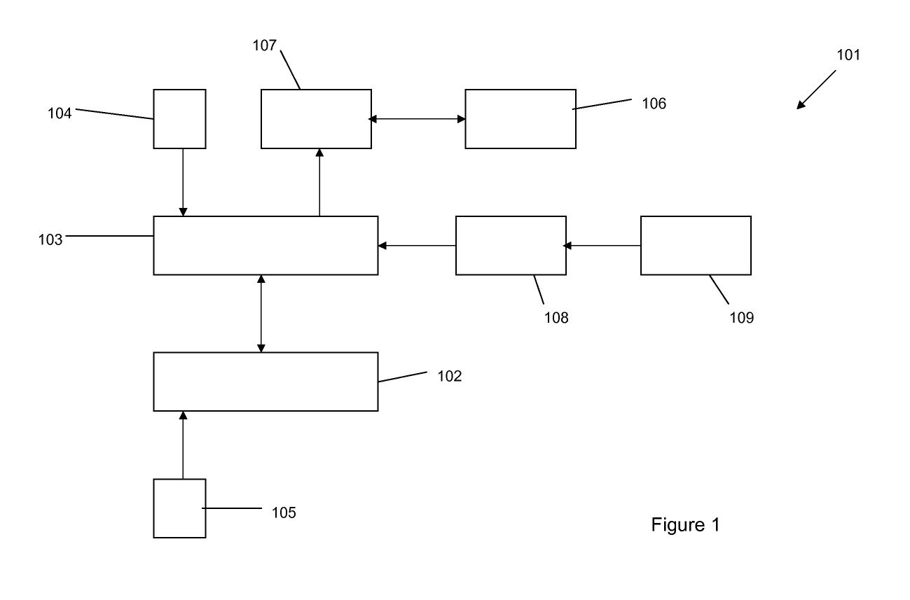

FIG. 1 shows a simplified block diagram of a system in accordance with many embodiments of the present invention.

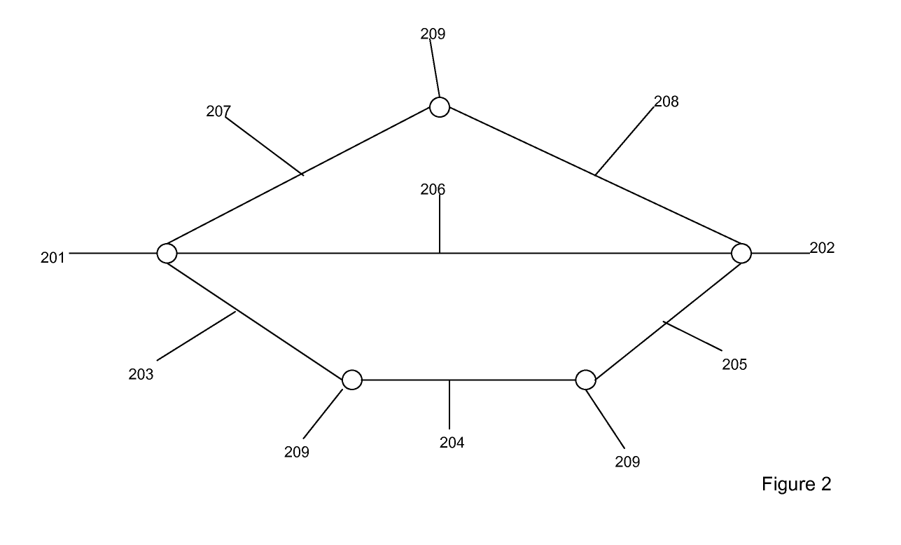

FIG. 2 shows an example of a connectivity path in accordance with many embodiments of the present invention.

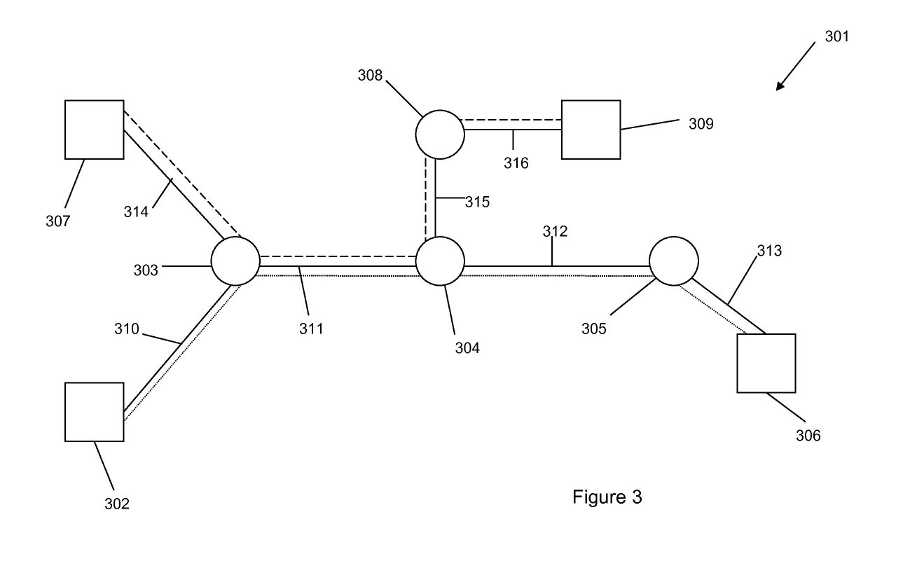

FIG. 3 shows an example according to many embodiments of the present invention.

The system 101 shown in FIG. 1 includes a trading engine 102 that may receive seller input 105 and is operatively connected to a routing engine 103. The routing engine 103 may receive buyer input 104 and may be operatively connected to a reservation engine 107 and a quality assurance component 108. The reservation engine 107 may be operatively connected to a provisioning component 106. The quality assurance component 108 may receive quality reports 109.

The system 101 provides or enables a flexible and efficient mechanism for trading virtual products and services. In particular, the system 101 enables a flexible mechanism for buying connectivity paths and selling connectivity legs.

A connectivity path may be considered a whole path between A and B over which data may be transmitted between A and B. The connectivity path is a single path that may include one or more connectivity legs where each connectivity leg could span a different network operator's network. However, the buyer is only aware of, or needs, the end to end connectivity path and so is not aware of, nor cares about, the individual connectivity legs or the actual physical connections of the connectivity path. In order to provide a connectivity path the connectivity path requires sufficient capacity for the buyer's needs to transmit or receive data. Therefore, the connectivity legs of the connectivity path need sufficient capacity for the buyer's needs. The trading mechanism of many of the embodiments determines or identifies connectivity paths which include connectivity legs that have sufficient spare capacity and fulfil both the buyer criteria and the seller criteria of each connectivity leg and of the connectivity path.

The connectivity path requested or the connectivity leg offered may include capacity which may be traded in predetermined blocks. For example, the system may predetermine that the connectivity capacity may be traded in 1 Megabit per second (Mbps) blocks, 5 Mbps, 10 Mbps, and so on. The predetermined block size traded may be determined by and depend on the provider of the system 101. The connectivity may also include a predetermined time period so capacity may be traded for set time periods such as 1 hour, 3 hours, 6 hours, 12 hours, 24 hours, and so on. The predetermined time periods traded may be determined by and depend on the provider of the system 101.

A connectivity path is a path between two points which enables or provides connectivity for the transmission of data between the two points. The connectivity path may include one or more legs where each of those legs may be provided by the same or different network operators and connectivity across each leg may be offered for use by the network operators or an entity that may have previously obtained or bought the connectivity on the leg from the relevant network operator.

An example of different connectivity paths between two points, 201 and 202 is shown in FIG. 2. Considering, a customer wishes to transmit data between end point 201, which for example is in San Francisco, and end point 202 which for example is in New York, then there may be several connectivity paths available.

For example, the first connectivity path may include legs 207 and 208 where leg 207 may span a first network operator's network and leg 208 may span a second network operator's network.

The second connectivity path may include a single leg 206 which spans a third network operator's network.

The third connectivity path may include legs 203, 204 and 205 where legs 203 and 204 span the first network operator's network and leg 205 spans the second network operator's network.

Each leg spans the network operator's network between network elements 209, start point 201 and end point 202.

If the legs are not fully utilised then the network operator's may offer for use the connectivity on each leg that the customer requires. However, if the network operator's have sold all the available connectivity on each of the legs to an entity then the entity may wish to offer spare capacity that they have obtained for use by the customer. Traditionally, the customer will have to negotiate with each of the network operators in order to determine which connectivity path may be able to fulfil the customer's requirements. If all capacity has been sold by the network operators then the customer will not be able to find out which entity has obtained the capacity and therefore will not be able to transmit data from San Francisco 201 to New York 202 even if the entity that has obtained the capacity is not utilising all the capacity or is not utilising the capacity during particular time periods.

The connectivity path may be required between two end points, e.g. an end to end path, the connectivity path may be required between an end point and an edge point, e.g. end to edge path, or the connectivity path may be required between an edge point and an edge point, e.g. an edge to edge path. An edge point is the entry or exit point to a local network which may be a business network, city wide network, and so on.

Returning now to FIG. 1, the system 101 enables the connectivity to be traded by not only the network operators but also any entity that has obtained connectivity which they are not fully utilising.

The routing engine 103 may receive a buyer request from a buyer that wishes to obtain connectivity between two points for the transmission of data. The buyer request may include buyer criteria which define or specify the criteria for the connectivity path that the buyer wishes to obtain. The buyer criteria may include, for example, a start point, an endpoint, service level parameters, a start time, an end time or a duration, price, and so on.

The start point and end point may be defined by co-ordinates, by clicking on a map, and so on. The service level parameters may include, for example, bandwidth, jitter, packet loss, availability, delay, and so on. The price may refer to a total price or price range for the connectivity path, a total price or price range for each possible leg that may be part of the connectivity path. The price may be left empty which may indicate the buyer is willing to agree to the price requested for the connectivity path (or any leg that is part of the connectivity path).

The buyer criteria mentioned hereinabove are examples of criteria that the buyer may specify or define. The buyer criteria may include one or more of the criteria mentioned above or may include any other criteria necessary in order to define and obtain the connectivity they require.

The routing engine 103, on receipt of the buyer request and any buyer criteria included in the buyer request, may determine or identify possible connectivity paths between the start point and the end point specified by the buyer as part of the buyer criteria. The one or more possible connectivity paths may include one or more legs where each leg is offered for use or sale by a seller.

Each of the legs forming each of the possible connectivity paths may span one or more network operator's networks and the connectivity on one or more of those legs may be owned by the network operator or another entity that has bought the connectivity from the network operator. Therefore, the seller may be the network operator or may be the other entity.

The routing engine 103, in order to identify one or more connectivity paths may request from or interact with the trading engine 102 details of legs that are currently offered for sale or for use. Based on legs that are currently offered for sale or use, the routing engine 103 can identify one or more connectivity paths between the start point and the end point.

Once the routing engine 103 has identified or determined one or more possible connectivity paths then the routing engine may determine one or more available connectivity paths based on the buyer criteria. An available connectivity path is one that meets the buyer criteria. In other words, not all of the identified connectivity paths may meet the buyer criteria and therefore not all of the identified connectivity paths may be available for the buyer.

The routing engine 103 may determine the one or more available connectivity path by considering each identified connectivity path in turn. For each identified connectivity path the routing engine 103 may determine for each leg of the identified connectivity path that the leg fulfils or meets relevant criteria of the buyer criteria. As described hereinabove, the buyer criteria may include any criteria that the buyer attaches to the buyer request where some of those criteria (e.g., the relevant criteria) may be relevant to the legs of a connectivity path.

The routing engine 103 may also determine whether the relevant buyer criteria for each leg fulfil the relevant seller criteria of the seller of the connectivity or capacity of the leg. The buyer may only obtain the connectivity or capacity on the leg if the relevant criteria of the seller criteria are fulfilled. The seller criteria and fulfilling the relevant seller criteria will be described further below.

Once the routing engine 103 has determined the legs which fulfil or meet the relevant criteria of the buyer criteria then the routing engine 103 may determine which of the connectivity paths as a sum of the respective legs fulfil or meet relevant criteria (criteria relating to the connectivity path) of the buyer criteria.

Based on the determination that each leg of the connectivity path fulfils the relevant buyer criteria and on the determination that the connectivity path as a whole fulfils the relevant buyer criteria then the one or more available connectivity paths are determined. If the buyer criteria does not include criteria that are relevant to the connectivity path as a whole then the determination of the one or more available connectivity paths may be based only on the determination that each leg of the connectivity path fulfils the relevant buyer criteria.

Once the routing engine 103 has determined one or more available connectivity paths then the routing engine 103 may select the optimum connectivity path from the one or more available connectivity paths. If only one available connectivity path is determined then the routing engine 103 will select that available connectivity path as the optimum connectivity path. If more than one available connectivity path is determined then the routing engine 103 may determine a weighting value for each of the available connectivity paths. The weighting value determined may be based on the buyer criteria and it may be determined that the available connectivity path with the lowest weighting value is the optimum connectivity path.

Once the routing engine 103 has selected an optimum connectivity path then the routing engine 103 will transmit details of the optimum connectivity path to the reservation component 107. The reservation component 107 may reserve the one or more legs of the optimum connectivity path from the seller of the leg, where the seller may be the network operator or an entity which is offering connectivity for the leg for sale.

Either at the time that the reservation component 107 reserves the one or more legs of the optimum connectivity path or at the time that the connectivity path is required by the buyer the details of the legs may be transmitted to the provisioning component 106. The provisioning component 106 may transmit a request to the network operator that provides the infrastructure for each leg to provision the connection for the buyer over that leg. The provisioning component 106 may interact directly with the management systems of the network operators in order to automatically provision the connection over the network operator's network.

The buyer will then receive the connectivity that the buyer requested and can transmit data between the start point and the end point for the duration of the provisioned connectivity. At the point of reserving the legs of the optimum connectivity path or when the connectivity path is provisioned then the trading mechanism may transfer funds from the buyer to the seller for each leg.

A quality assurance component 108 may receive quality reports from the network operators over which the connectivity path for the buyer spans. The quality assurance component 108 may receive quality reports periodically, for example, every 24 hours. The quality report may contain details regarding the quality of service (e.g. bandwidth, jitter, packet loss, availability, delay, and so on) and the quality assurance component 108 may determine whether the buyer is receiving the level of service they requested. If the buyer is not receiving the level of service they requested according to the relevant buyer criteria then the quality assurance component 108 may request the routing engine 103 to determine and select a different optimum connectivity path for the buyer. A network operator or other entity selling the affected leg may cover the cost of altering the connectivity path for the buyer.

If no available connectivity path is determined or selected for the buyer then the buyer request may be considered as waiting and the routing engine 103 may reconsider the buyer request either periodically or at the point in time further connectivity (or capacity) is offered for sale by a seller. Once one or more possible connectivity paths are identified then the system 101 may follow the mechanism described herein above for determining an optimum connectivity path. Alternatively, if possible connectivity paths are identified but none of the identified connectivity paths are determined as available or optimum then the routing engine 103 may provide the buyer with details of the identified possible connectivity paths (which do not fulfil the relevant criteria of the buyer criteria) to see if the buyer wishes to choose one of the possible connectivity paths. If the buyer selects one of the possible connectivity paths then the routing engine 103 may consider that selected connectivity path as the available connectivity path and as the optimum connectivity path.

If the buyer having a connectivity path identified and provisioned decides that they no longer need one or more legs of the connectivity path either in total or part of the capacity of the leg then the buyer may offer the connectivity or capacity for sale via the system 101. The selling mechanism will now described.

A seller may be a network operator that has spare capacity in their network or may be an entity that has bought or obtained capacity on a leg and wishes to re-sell part or all of the capacity.

The trading engine 102 may receive a seller request via an input 105 from a seller where the seller request may include seller criteria. The seller criteria may define or specify the criteria for the capacity on a leg that the seller wishes to sell or trade. The seller criteria may include, for example, a start point of the leg, an end point of the leg, service level parameters, a start time, an end time or a duration, price, and so on.

The start point of the leg and the end point of the leg may be defined by co-ordinates, by clicking on a map, may be defined by the start and end network elements of the leg, the network domains that the leg connects between, and so on. The service level parameters may include, for example, bandwidth, jitter, packet loss, availability, delay, and so on relevant to the leg that the seller is selling. The price may refer to a total price or price range for the capacity on the leg. The price may be left empty which may indicate the seller is willing to accept the price offered for the capacity on the leg by the buyer.

The seller criteria mentioned hereinabove are examples of criteria that the seller may specify or define. The seller criteria may include one or more of the criteria mentioned above or may include any other criteria necessary in order to define and sell capacity on a leg.

If the seller is a network operator then the network operator may automatically input the seller requests directly from the network operator's management systems if the management systems identify spare capacity on a leg in the network operator's network.

The seller may offer for sale capacity on a leg where the capacity is provided in predetermined blocks, for example, 1 Megabit per second (Mbps) blocks, 5 Mbps, 10 Mbps, and so on. The predetermined block size traded may be determined by and depend on the provider of the system 101. The connectivity may also include a predetermined time period so capacity may be traded for set time periods such as 1 hour, 3 hours, 6 hours, 12 hours, 24 hours, and so on. The predetermined time periods traded may be determined by and depend on the provider of the system 101.

The seller may offer, for example, 100 Mbps on a leg and a buyer may buy 20 Mbps. The remaining 80 Mbps may automatically be re-offered for sale by the trading engine 102. Similarly, if the seller offers for sale 20 Mbps for 4 hours between 16:00 and 20:00 and a buyer buys the 20 Mbps for 2 hours between 16:00 and 18:00 then the trading engine 102 may automatically re-offer for sale the capacity on the leg for the duration between 18:00 and 20:00. The trading mechanism or the seller via their seller criteria may also define that the offered capacity and/or the offered time duration may not be split in blocks and should be sold as a total amount. Thus, the trading engine 102 provides a very flexible mechanism for selling or offering for sale capacity on a leg.

The trading engine 102 maintains a store of the capacity on each leg that each of the sellers is offering for sale along with the seller's criteria for each offer.

As described hereinabove, when a buyer requests a connectivity path between a start point and an end point the routing engine 103 requests details of the legs that are offered for sale from the trading engine 102. The routing engine 103 identifies one or more connectivity paths where each connectivity path includes one or more legs from the trading engine 102. Therefore, the routing engine 103 may identify if the connectivity leg offered for sale by the seller falls within, or is part of, one or more possible connectivity paths for the buyer.

The routing engine 103 then determines one or more available connectivity paths based on the buyer's criteria before selecting the optimum path from the available connectivity paths for the buyer. At the stage that the routing engine 103 is determining the one or more available connectivity paths, the routing engine 103 may determine whether the relevant criteria of the seller criteria, e.g. price, is fulfilled. The determination as to whether the seller criteria are fulfilled may be based on the relevant buyer criteria. If the relevant criteria of the seller criteria is not fulfilled then the routing engine 103 may determine that the connectivity leg offered for sale by the seller is not part of one or more available connectivity paths for the buyer.

If the connectivity leg offered for sale by the seller is part of one or more available connectivity paths for the buyer then the routing engine 103 may select an optimum connectivity path for the buyer from the one or more available connectivity paths, as described hereinabove.

If the connectivity leg offered for sale by the seller is part of the optimum connectivity path for the buyer then the reservation component 107, described hereinabove, may reserve the capacity on the leg for the specified duration of time from the seller. The seller may then receive payment for the capacity on the leg for the duration of time that has been sold to the buyer.

A clearing component may after a predetermined time period, e.g. every 24 hours, may identify connectivity legs offered for sale by a seller that have not been bought by a buyer. The clearing component may, for example, reduce the price requested by the seller in order to attempt to sell the connectivity leg.

An example of buying a connectivity path and selling of a connectivity leg will now be described, by way of example only, and with reference to FIG. 3 which shows a simplified network topology 301.

In this example, a hospital 302 has purchased a connectivity path (shown by the dotted line in FIG. 3) between the hospital 302 and a data storage centre 306. The connectivity path for the hospital 302 includes four connectivity legs which are implemented on the physical connections 310, 311, 312 and 313 where each of the physical network connections may be implemented by a different network operator.

Therefore, the connectivity path (shown as a dotted line in FIG. 3) from the hospital 302 to the data storage centre 306 includes a first connectivity leg on physical network connection 310 between the hospital 302 and a network element 303, a second connectivity leg on physical network connection 311 between network elements 303 and 304, a third connectivity leg on physical network connection 312 between network elements 304 and 305, and a fourth connectivity leg on physical network connection 313 between network element 305 and the data storage centre 306.

Assuming that the maximum capacity of each connectivity leg (and therefore on the physical network connections) is 10 Mbps and that the hospital 302 has obtained or purchased a connectivity path from the hospital 302 to the data centre 306 of 10 Mbps for 24 hours via the trading mechanism of the embodiments of the present invention then there is currently no spare or available capacity on each of the connectivity legs at any time during the 24 hours. Therefore, the hospital 302 may transmit data to and/or receive data from the data storage centre 306.

In this example, a company wishes to have a video conference between a first office at 307 and a second office at 309. The company, e.g. the buyer, may input a buyer request for a connectivity path between the first office 307 and the second office 309. The buyer request may include buyer criteria where the buyer criteria specifies that the connectivity path is for 10 Mbps, for a time period of 1 pm to 4 pm, for a maximum price of $200, and the coordinates of the first office 307 and the second office 309. The buyer criteria may also define required service level parameters.

Assuming that the only possible physical network connection between the first office 307 to the second office 309 is via the physical network connections 314 between the first office 307 and network element 303, 311 between network elements 303 and 304, 315 between network elements 304 and 308 and 316 between network element 308 and the second office 309. The buyer is not aware of the individual physical network connections or the individual connectivity legs as the buyer is requesting a connectivity path.

On receipt of the buyer request for a connectivity path, the routing engine may attempt to identify one or more connectivity paths between the first office 307 and the second office 309. The routing engine may request connectivity legs that are offered for sale by a seller from the trading engine. The trading engine may provide the routing engine with details that a connectivity leg over physical connection 314, a connectivity leg over physical network connection 315 and a connectivity leg over physical network connection 316 are offered for use by a seller.

However, as the hospital 302 has all capacity on physical network connection 311 then there is no connectivity leg over physical connection 311 offered for sale. Thus, the routing engine cannot identify one or more connectivity paths or determine an available connectivity path for the buyer. The buyer request may be considered by the routing engine as waiting as it has not been fulfilled.

At a particular time, the hospital 302 may decide that they are not utilising the capacity on their connectivity path between 1 pm and 6 pm. Therefore, the hospital may input a seller request to the trading engine in order to be able to re-sell the connectivity the hospital 302 has. The seller request may include seller criteria where the seller criteria may specify that the connectivity path (therefore all connectivity legs forming the connectivity path), or one or more particular connectivity leg is being offered for sale. The seller criteria may further specify the capacity offered on each leg, which in this example is for the total 10 Mbps. The seller criteria may further specify that the seller is offering the connectivity legs for sale for a time period of 1 pm to 4 pm. As described hereinabove, the seller criteria may include any criteria, for example, a requested price, service level parameters, and so on.

The trading engine receives the seller request and may inform the routing engine of the connectivity leg(s) offered for sale or may wait until requested to provide the details from the routing engine.

The routing engine with the details of the new seller request for the connectivity legs may identify a connectivity path for the company (e.g. the buyer) to provide the buyer requested connectivity path. The routing engine identifies a connectivity path for the buyer where the identified connectivity path is shown as the dashed line in FIG. 3.

The routing engine will determine if the identified connectivity path is an available connectivity path for the buyer by determining if the relevant criteria of the seller criteria fulfil the relevant criteria of the buyer criteria. Similarly, the routing engine may determine that relevant criteria of the buyer criteria fulfil the relevant criteria of the seller criteria. In this example, the relevant criteria of both the seller criteria and the buyer criteria are fulfilled.

The routing engine informs the reservation component of details of the connectivity path and the reservation component reserves the connectivity leg between 303 and 304 from the hospital 302 and similarly the connectivity legs between 307 and 303, between 304 and 308, and between 308 and 309 from the sellers of those connectivity legs.

At the time of reserving the connectivity legs, or at the time that the connectivity path is required by the buyer, the reservation component may inform the provisioning component of details of the connectivity path. The provisioning component may interact with the management systems of the network operator's providing each of the physical network connections in order to provision the connectivity path for the buyer.

The buyer, e.g. the company, may between 1 pm and 4 pm utilise the connectivity path (shown as a dashed line in FIG. 3) in order to have their video conference between the first office 307 and the second office 309. If the video conference is cancelled then the buyer, e.g. the company, may use the trading engine to offer for sale the connectivity they have purchased.

The system of the embodiments may also transfer funds to the seller at the time of reserving the connectivity and may also monitor the service level of the connectivity path, based in reports from the management systems of the network operators to ensure that the buyer is receiving the service level they have requested.

The example shown in FIG. 3 and described hereinabove is a simplified example where only one connectivity path was possible. However, as will be appreciated several possible connectivity paths may be identified and traded by the embodiments of the present invention.

Accordingly, many of the embodiments enable a flexible and efficient mechanism for buying connectivity paths and selling connectivity legs. A buyer may flexibly re-sell any connectivity they have bought. The connectivity path and the connectivity legs are virtual products which the mechanism of many of the embodiments enables flexible and efficient trading thereof without the buyer or seller needing to know or understand how the connectivity path or connectivity legs are implemented on a physical network provided by a network operator.

While embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method comprising:
receiving a buyer request for a connectivity path wherein said buyer request includes a buyer criteria;
identifying one or more connectivity paths wherein each identified connectivity path comprises one or more connectivity legs;
determining one or more available connectivity paths based on said buyer criteria; and
selecting an optimal connectivity path from said determined available connectivity paths.

2. The method as claimed in claim 1 in which said step of determining one or more available connectivity paths further comprises:
determining if each of said one or more connectivity legs of said identified connectivity path fulfils relevant criteria of said buyer criteria.

3. The method as claimed in claim 1 in which said step of determining one or more available connectivity paths further comprises:
determining if said identified connectivity path fulfils relevant criteria of said buyer criteria.

4. The method as claimed in claim 1 which said step of selecting an optimal connectivity path from said determined available connectivity paths comprises:
determining a weighting value for each determined one or more available connectivity paths; and
selecting the available connectivity path with the optimum weighting value as said optimum connectivity path.

5. The method as claimed in claim 1 further comprising:
reserving said one or more connectivity legs of said selected optimum connectivity path.

6. The method as claimed in claim 1 further comprising:
provisioning said selected optimal connectivity path such that said buyer can utilise said selected optimal connectivity path.

7. The method as claimed in claim 1 in which each of said one or more connectivity legs are offered for use by a seller and include seller criteria.

8. The method as claimed in claim 7 in which said step of determining one or more available connectivity paths comprises:
determining if relevant criteria of buyer criteria for each connectivity leg of said identified connectivity path fulfil relevant criteria of said seller criteria of each of said connectivity legs.

9. An apparatus comprising:
a first input adapted to receive a buyer request for a connectivity path wherein said buyer request includes a buyer criteria;
a first processor adapted to identify one or more connectivity paths wherein each identified connectivity path comprises one or more connectivity legs;
a second processor adapted to determine one or more available connectivity paths based on said buyer criteria; and
a third processor adapted to select an optimal connectivity path from said determined available connectivity paths.

10. The apparatus as claimed in claim 9 in which said second processor is further adapted to determine if each of said one or more connectivity legs of said identified connectivity path fulfils relevant criteria of said buyer criteria.

11. The apparatus as claimed in claim in which said second processor is further adapted to determine if said identified connectivity path fulfils relevant criteria of said buyer criteria.

12. The apparatus as claimed in claim 9 in which said third processor is further adapted to:
determine a weighting value for each determined one or more available connectivity paths; and
select the available connectivity path with the optimum weighting value as said optimum connectivity path.

13. The apparatus as claimed in claim 9 further comprising:
a fourth processor adapted to reserve said one or more connectivity legs of said selected optimum connectivity path.

14. The apparatus as claimed in claim 9 further comprising:
a fifth processor adapted to provision said selected optimal connectivity path such that said buyer can utilise said selected optimal connectivity path.

15. The apparatus as claimed in claim 9 in which each of said one or more connectivity legs are offered for use by a seller and include seller criteria; wherein said second processor is further adapted to:
determine if relevant criteria of buyer criteria for each connectivity leg of said identified connectivity path fulfils relevant criteria of said seller criteria of each of said connectivity legs.

16. A computer program product comprising computer readable executable code for:
receiving a buyer request for a connectivity path wherein said buyer request includes a buyer criteria;
identifying one or more connectivity paths wherein each identified connectivity path comprises one or more connectivity legs;
determining one or more available connectivity paths based on said buyer criteria; and
selecting an optimal connectivity path from said determined available connectivity paths.
